(19) United States
(12) Patent Application Publication
(10) Pub. No.: US 2025/0288895 A1
(43) Pub. Date: Sep. 18, 2025

(54) Bridgebuddy

(71) Applicant: Arnold Lipes, Cote Saint-Luc (CA)

(72) Inventor: Arnold Lipes, Cote Saint-Luc (CA)

(21) Appl. No.: 18/604,711

(22) Filed: Mar. 14, 2024

(51) Int. Cl. A63F 1/00; G06V 20/60

(52) U.S. Cl. CPC A63F 1/00; G06V 20/60; A63F 2001/001

(57) ABSTRACT

A portable cabinet that houses a computer with the capacity of being programmed for playing contract bridge, and that includes card reader devices that can identify the cards and are suitable to accept the download of software that allows them to read playing cards and transfer the description to the computer, and a method of displaying the card that the computer chooses to play.

### BACKGROUND OF INVENTION

People who enjoy competition, playing chess or checkers, can join in tournaments on their own. However in contract Bridge, you need a partner to join in a tournament.

Our invention is a computer-driven device {hereinafter referred to as Bridgebuddy} that is portable, will take the same space as a person at the card table, and will serve as the partner required to join a tournament.

Previous experiments with contract bridge and artificial intelligence have shown that it has the capability of playing at the level of the world's best players. Therefore, if the player teamed with Bridgebuddy does well in tournaments, then a market could develop world-wide for this device.

### DESCRIPTION OF INVENTION

Bridgebuddy will be programmed by the owner (hereinafter referred to as Player 1) to play Contract BRIDGE using the same playing systems and conventions that he uses when playing in competition. As proof that such a task is possible, we refer to the website BRIDGE BASE ONLINE. This website offers players without partners, a computer named ROBOT, that has been programmed to play standard CONTRACT BRIDGE.

Each player at the table is dealt 13 cards. For Bridgebuddy, the dealer pushes the cards, face down, into the 13 slots in the front wall of the device's enclosure.

Each card slides over a 12″ long U-shaped channel, 3″ wide, with 1″ side walls. The channel is angled 45 degrees downwards toward the interior of the enclosure. A vertical flap covers the end of the channel and stops the travel of the card.

When the card stops, a card reader, located underneath the slide, reads the identity of the card through a cutout on the bottom of the slide. This information is transmitted to the computer.

The flaps that stop the cards are activated by linear solenoids controlled by the computer.

There are 13 of the above described slides in the device's enclosure.

When the computer wants to play one of the 13 cards, it signals the solenoid of the appropriate flap to swing away from that card. This allows that card to drop downwards onto the exit slide plate, and exit out the front of the enclosure, face up, for the 3 players at the table to see.

Each of the players is given a card reader placed directly in front of them. When any of the three players decides to play a card, or make a bid, they must press a button and show the playing card, or bidding card, to that card reader. This information is transferred to the computer.

A message screen mounted on the front wall of Bridgebuddy informs the players of the bid that it wants to make during the auction.

When Bridgebuddy is playing the hand, it indicates the card it wants to play by releasing that card out the bottom of the chosen slot, onto the table.

If Bridgebuddy is the “dummy”, then its cards are all released, face up, onto the table.

### EXPLANATION OF DRAWINGS

FIG. 1 A playing card, face down, enters a slot in the front panel of the computer enclosure box. The dealer is responsible for putting a card, face down, in all 13 slots.

FIG. 2 The card, face down, slides down the entrance slide, and stops when it comes in contact with the closed flap door. At that point, the card reader scans the card face and it's Identity is transmitted to the controlling computer.

FIG. 3 When the computer chooses a card to play, it activates the solenoid associated with that card, the door flap opens, and the card falls onto the exit slide, face up.

FIG. 4 The card slides downward out the front of the enclosure, and appears, face up, onto the card table, for the three players to see.

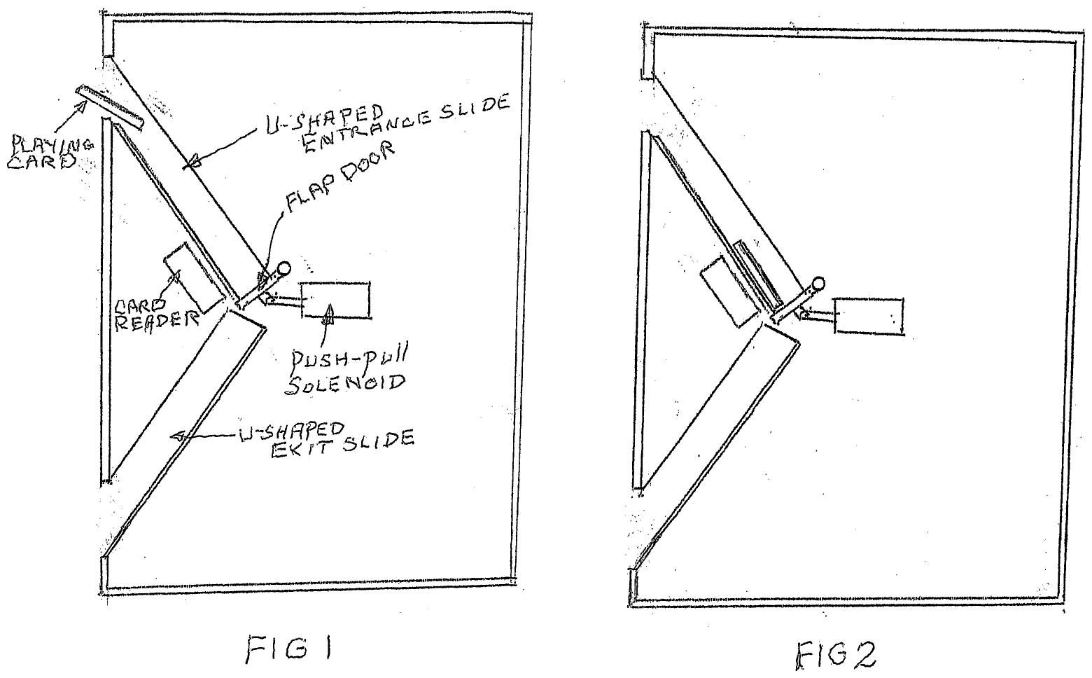

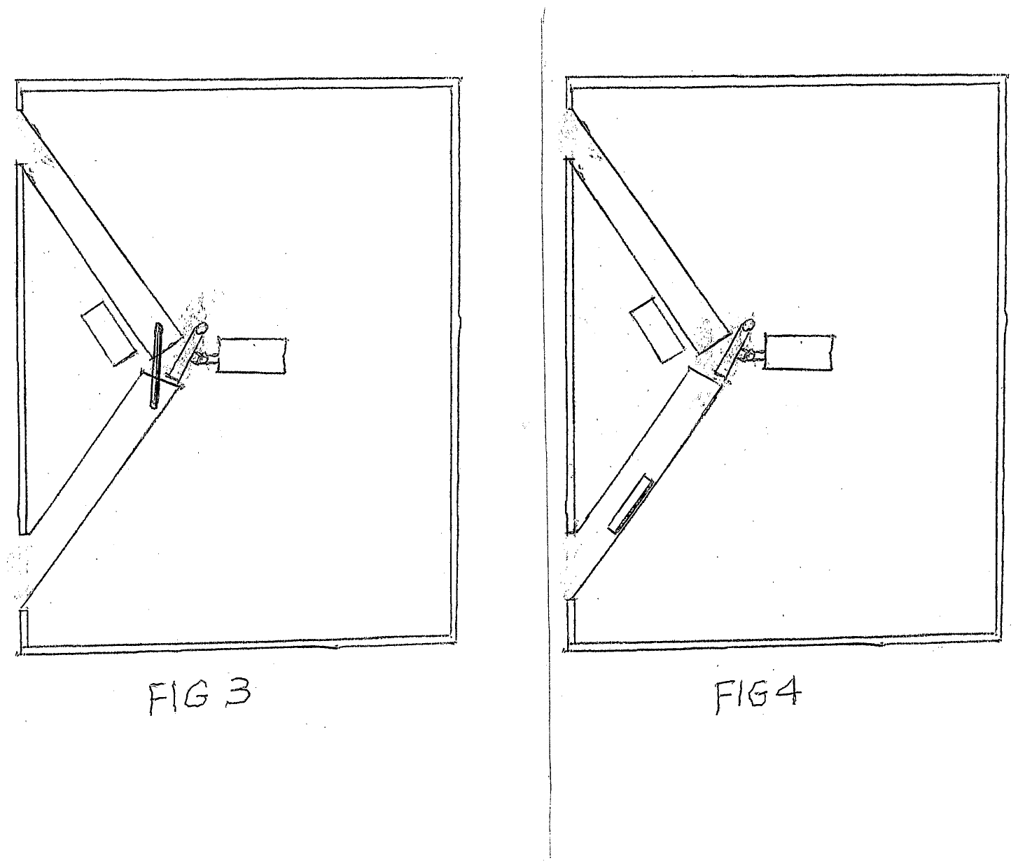

What I claim is:

1. A portable cabinet that is large enough to house a computer with the capacity of being programmed to playing contract bridge, and 13 cardreaders that can recognize bridge cards and transfer the description to the computer.

2. A portable cabinet as mentioned in claim 1 that has a monitor screen mounted oh the exterior wall and is connected to the computer to inform other players of the computer's bid. during the auction process.

3. A portable cabinet as mentioned in claim 1 that has 3 additional card readers connected to the computer, each having the card reading capacity, to be used by the 3 people playing with bridgebuddy.

4. A portable cabinet as mentioned in claim 1 wherein the cabinet can fit onto a standard card table, allowing sufficient room for three other players.
